(19) United States
(12) Patent Application Publication
(10) Pub. No.: US 2018/0061135 A1
(43) Pub. Date: Mar. 1, 2018

(54) IMAGE DISPLAY APPARATUS AND IMAGE DISPLAY METHOD

(71) Applicant: FUJITSU LIMITED, Kawasaki-shi (JP)

(72) Inventor: Rikiya Watanabe, Kawasaki (JP)

(73) Assignee: FUJITSU LIMITED, Kawasaki-shi (JP)

(21) Appl. No.: 15/677,757

(22) Filed: Aug. 15, 2017

(30) Foreign Application Priority Data
Aug. 24, 2016 (JP) 2016-163908

(51) Int. Cl. G06T 19/00; G06F 3/01

(52) U.S. Cl. CPC G06T 19/006; G06F 3/011

(57) ABSTRACT

An image display apparatus sets a predetermined transparency for each pixel of at least one of a first image and a second image, the first image including an image of a communication device including a plurality of ports in a first state in a cable connection and the second image including an image of the communication device in a second state in the cable connection, aligns the image of the communication device included in the first image with the image of the communication device included in the second image, combines the first image and the second image aligned to each other according to the transparency to create a composite image, and displays the composite image on a display apparatus.

### CROSS-REFERENCE TO RELATED APPLICATION

This application is based upon and claims the benefit of priority of the prior Japanese Patent Application No. 2016-163908, filed on Aug. 24, 2016, and the entire contents of which are incorporated herein by reference.

### FIELD

The embodiments discussed herein are related to an image display apparatus and an image display method.

### BACKGROUND

In the related art, providing users with various pieces of information and supporting users' behaviors by using augmented reality (AR) have been studied (for example, see Japanese Laid-open Patent Publication No. 2014-38523 and Japanese Laid-open Patent Publication No. 2012-152016). For example, in the technique disclosed in Japanese Laid-open Patent Publication No. 2014-38523, a video which is displayed in a certain place, is switched between a video currently being captured at the certain place, a video captured in the past at the certain place, and a composite image acquired by superimposing these videos.

In the technique disclosed in Japanese Laid-open Patent Publication No. 2012-152016, when the identification number of a target connector attached to an end of a cable is input, positional information of the connector is acquired, and guidance information that guides a worker to the position of the target connector is displayed on a display unit of a head-mounted display.

### SUMMARY

A communication device such as a router and a switching hub has a plurality of ports and cables are connected to these ports. When the cables are connected to the communication device, some of the ports may be hidden by these cables and thus a worker may not be able to visibly confirm the hidden ports. Therefore, in order to support tasks such as connection, removal, and replacement of a cable in the communication device as described above (hereinafter, referred to as a “cable connection task” for the sake of convenience), AR is preferably used.

However, in the technique disclosed in Japanese Laid-open Patent Publication No. 2014-38523, it is assumed that the current video and past video are both captured at the same place. However, the position where the target communication device is imaged and the direction of a camera with respect to the communication device at the time of installation of the communication device may be different from those at the time of execution of the cable connection task. In particular, when the target communication device is captured with imaging equipment owned by a worker, for example, by a digital camera or a mobile phone equipped with a camera, it is highly possible that the imaging position or the like at the time of installation is different from that at the time of operation.

The technique disclosed in Japanese Laid-open Patent Publication No. 2012-152016 does not take into consideration a state in which a target connector cannot be visually recognized by a worker, and in such a case, the connection task related to the connector may not be adequately supported.

In one aspect, an image display apparatus is provided. The image display apparatus includes a processor configured to: set predetermined transparency for each pixel of at least one of a first image and a second image, the first image including an image of a communication device including a plurality of ports in a first state in a cable connection and the second image including an image of the communication device in a second state in the cable connection; align the image of the communication device included in the first image with the image of the communication device included in the second image; combine the first image and the second image aligned to each other according to the transparency to create a composite image; and display the composite image on a display apparatus.

In another aspect, an image display method is provided. The image display method includes: setting predetermined transparency for each pixel of at least one of a first image and a second image, the first image including an image of a communication device including a plurality of ports in a first state in a cable connection and the second image including an image of the communication device in a second state in the cable connection; aligning the image of the communication device included in the first image with the image of the communication device included in the second image; combining the first image and the second image aligned to each other according to the transparency to create a composite image; and displaying the composite image on a display apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a hardware configuration of a terminal in which an image display apparatus according to an embodiment is embedded.

FIG. 2 is a functional block diagram of a control unit related to an image display process.

FIG. 3A illustrates an example of a reference image before being processed.

FIG. 3B illustrates an example of a reference image after being processed.

FIG. 4 is an operation flowchart of a reference image registration process.

FIG. 5A illustrates an example of a current image.

FIG. 5B illustrates an example of a composite image.

FIG. 6 is an operation flowchart of an image display process.

FIG. 7 is a schematic configuration drawing of a client-server system in which the image display apparatus according to the embodiment described above or a modification thereof is mounted.

### DESCRIPTION OF EMBODIMENTS

Referring now to the drawings, an image display apparatus will be described. The image display apparatus displays a composite image created by superimposing two images acquired by imaging a communication device, such as a router or a switching hub, having a plurality of ports for connecting cables in different conditions of cable connection. In this case, the image display apparatus creates a composite image by, for example, making one of an image of the communication device with no cable connected and an image of the communication device with one or more cables connected translucent, and aligning the images of the communication device on the respective images.

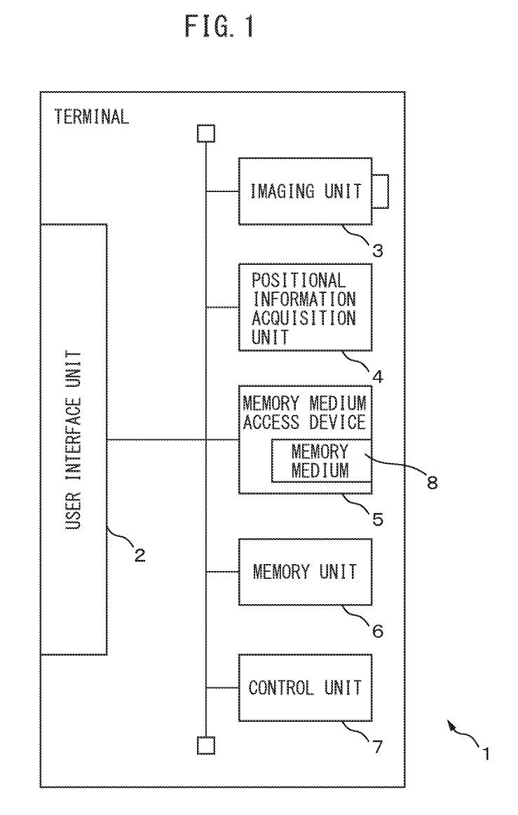

FIG. 1 is a diagram illustrating a hardware configuration of a terminal in which an image display apparatus according to an embodiment is embedded. A terminal 1 includes a user interface unit 2, an imaging unit 3, a positional information acquisition unit 4, a memory medium access device 5, a memory unit 6, and a control unit 7. The user interface unit 2, the imaging unit 3, the positional information acquisition unit 4, the memory medium access device 5, and the memory unit 6 are connected to the control unit 7 via signal lines. The terminal 1 is, for example, a mobile phone, a mobile information terminal, or a tablet-type computer. In addition, the terminal 1 may include a communication interface circuit (not illustrated) for connecting the terminal 1 to other apparatuses. Note that FIG. 1 is a diagram for illustrating components that the terminal 1 comprises, and is not a drawing illustrating the actual layout of the components of the terminal 1.

The user interface unit 2 is an example of the display apparatus and includes, for example, a liquid-crystal display or an organic electroluminescence display. The user interface unit 2, on a display screen thereof, displays various pieces of information such as an image created by the imaging unit 3 and a composite image to a user. The user interface unit 2 may include one or more operation buttons that allows a user to operate the terminal 1. Alternatively, the user interface unit 2 may include a touch panel display. In this case, the user interface unit 2 displays, for example, various icons or operation buttons according to control signals from the control unit 7. When the user touches a position of any of displayed icons or operation buttons, the user interface unit 2 creates an operation signal according to the position, and outputs the operation signal to the control unit 7.

The imaging unit 3 includes an image sensor having two-dimensionally arrayed solid-state imaging elements and an optical imaging system that forms an image of a target on the image sensor. The optical imaging system may be a single focus optical system, or may be a zoom optical system.

The imaging unit 3 captures the communication device as the target according to the user's operation, and creates an image in which the communication device appears. In this embodiment, the imaging unit 3 creates a color image represented in an RGB color system. Each time an image is created, the imaging unit 3 outputs the created image to the control unit 7. The imaging unit 3 may be incorporated into the terminal 1. Alternatively, the imaging unit 3 may be provided separately from the terminal 1. If the imaging unit 3 is provided separately from the terminal 1, the imaging unit 3 may be connected to the terminal 1 via, for example, a video cable or a cable for connecting peripheral equipment.

The positional information acquisition unit 4 acquires information indicating the position of the terminal 1 and an imaging direction of the imaging unit 3. The information indicating the position of the terminal 1 and the imaging direction of the imaging unit 3 are referred to simply as position information in the following description. The positional information acquisition unit 4 includes a receiver that receives a global positioning system (GPS) signal, a computing circuit that calculates the position of the terminal 1 from the GPS signal, and an orientation sensor that measures the imaging direction of the imaging unit 3. The orientation sensor includes, for example, a gyroscope sensor and a magnetic sensor. When the imaging unit 3 is provided separately from the terminal 1, the positional information acquisition unit 4, in particular, the orientation sensor is preferably provided in the imaging unit 3 in order to accurately measure the position and the imaging direction of the imaging unit 3. The positional information acquisition unit 4 may include another sensor which can acquire the positional information.

The positional information acquisition unit 4 acquires the positional information when the image is captured by the imaging unit 3, and outputs the positional information to the control unit 7.

The memory medium access device 5 is a device that accesses a memory medium 8 such as a semiconductor memory card. The memory medium access device 5 reads, for example, a computer program stored in the memory medium 8, which is executed on the control unit 7, and sends the same to the control unit 7. As described later, when the control unit 7 executes the computer program that implements a function as the image display apparatus, the memory medium access device 5 may read a computer program for displaying an image from the memory medium 8 and send the same to the control unit 7. The memory medium access device 5 stores an image of the communication device itself which is displayed, or a processed image and positional information at the time of image acquisition, the position of the communication device, an angle of view and a focal length of the imaging unit 3 received from the control unit 7 in the memory medium 8. In addition, the memory medium access device 5 may store information indicating the position of the communication device on the image received from the control unit 7 or the like in the memory medium 8.

The memory unit 6 includes, for example, a readable and writable non-volatile semiconductor memory and a readable and writable volatile semiconductor memory. The memory unit 6 stores various application programs which are executed by the control unit 7 and various data. The memory unit 6 may store an image which is subjected to an image display process, various data which is used in the image display process, and various data created in the course of the image display process.

The control unit 7 includes one or more processors and a peripheral circuit thereof. The control unit 7 is connected to each unit of the terminal 1 via signal lines to control the entire terminal 1.

The control unit 7 may operate as the image display apparatus.

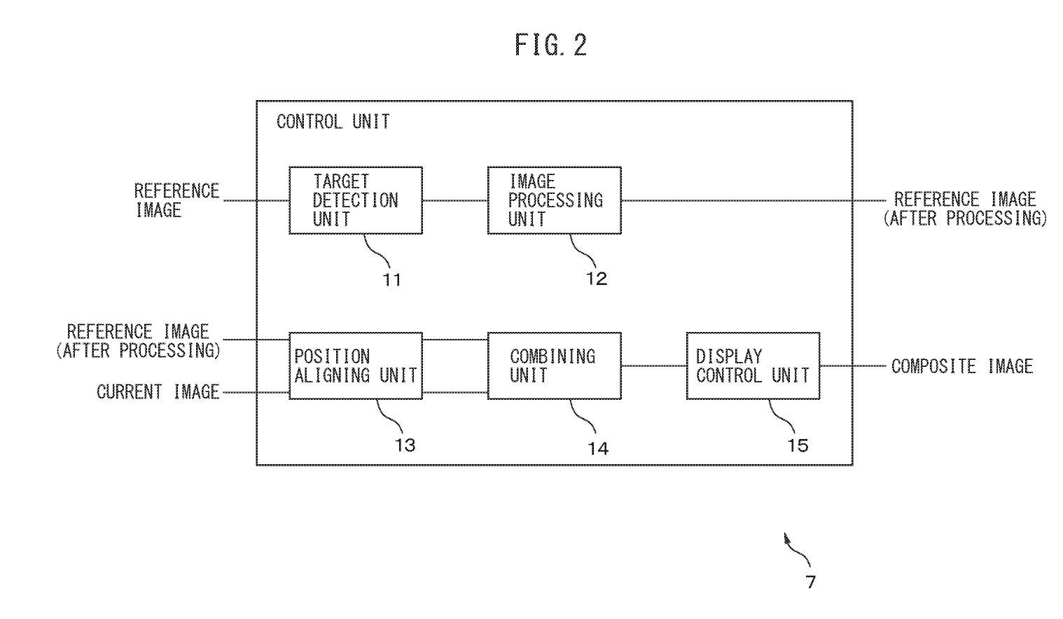

FIG. 2 is a functional block diagram of the control unit 7 related to an image display process. The control unit 7 includes a target detection unit 11, an image processing unit 12, a position aligning unit 13, a combining unit 14, and a display control unit 15. The respective units that the control unit 7 includes are implemented by, for example, a computer program that is executed by the control unit 7. The respective units that the control unit 7 includes may be mounted on the terminal 1 as one or more integrated circuits that realize functions of the respective units thereof separately from the processor that the control unit 7 comprises.

The control unit 7 executes a reference image registration process and the image display process. The reference image registration process is a process for registering a reference image in advance that is acquired by capturing the communication device in a state in which all of the ports of the communication device to which the cable connection task is applied are visible. In contrast, the image display processing is processing for combining the reference image and an image acquired by capture an image of the communication device at the time of operation and displaying the resulting composite image on the user interface unit 2. The target detection unit 11 and the image processing unit 12 relate to the reference image registration process. In contrast, the position aligning unit 13, the combining unit 14, and the display control unit 15 relate to the image display process.

In the following, the process performed by the respective units included in the control unit 7 will be described for the reference image registration process and for the image display process separately.

### (Reference Image Registration Process)

When the control unit 7 acquires, from the imaging unit 3, a reference image created by capturing the communication device which is a task subject from ports side of the communication device in a state in which all of the ports of the communication device are visible, the target detection unit 11 detects the communication device which is a task subject from the reference image. In the following description, the target communication device, which is a task subject, is referred to simply as the communication device.

For example, when an identification marker having a given shape such as an AR marker is provided on the communication device, the target detection unit 11 detects the identification marker in the reference image. For example, the target detection unit 11 detects an area of the reference image where the identification marker is included by template matching using a template of the identification marker. Since the size of the identification marker on the reference image varies in accordance with the distance between the terminal 1 and the communication device, the target detection unit 11 may use a plurality of templates having identification markers different in size from each other.

Alternatively, the target detection unit 11 may detect the area of the reference image including the identification marker by using an identifier which has been learned to detect the identification marker in advance. For example, the target detection unit 11 may use an AdaBoost identifier, a support vector machine, or a deep neural network as the identifier. The target detection unit 11 may determine whether or not the identification marker is included within the window by setting a window in a portion of the reference image, extracting features, for example, Haar-like features which are input to the identifier from the window, and inputting the features to the identifier. The target detection unit 11 can detect the identification marker irrespective of the position of the identification marker in the reference image by repeating the above-described processing while changing the position and the size of the window in the reference image. Since the position of the identification marker on the communication device is already known, the target detection unit 11 identifies the area of the reference image in which the communication device appears on the basis of a positional relationship between the identification marker and the communication device when detecting the identification marker on the reference image.

Alternatively, the target detection unit 11 may detect the communication device itself from the reference image. In this case as well, the target detection unit 11 may detect the area of the reference image in which the communication device appears by template matching using a template of the communication device. Alternatively, the target detection unit 11 may detect the area of the reference image in which the communication device appears by using an identifier which has been learned to detect the communication device in advance. In this case as well, the target detection unit 11 may detect an area in which the communication device appears by performing the same processing as that performed when the identifier for detecting the identification marker described above is used.

Alternatively, the target detection unit 11 may detect two or more feature points of the communication device from the reference image. For example, the target detection unit 11 may detect the respective corners of the communication device as feature points. In order to detect the feature points described above, the target detection unit 11 may use a corner detection filter such as a Harris filter. When the size and the shape of an area surrounded by a set of four feature points among the detected feature points match the estimated size and the estimated shape of the communication device in the reference image, the target detection unit 11 detects the corresponding area surrounded by the feature points as an area in which the communication device appears.

The target detection unit 11, upon detection of the identification marker of the communication device in the reference image, notifies information indicating the position and the size of the area where the identification marker appears to the image processing unit 12. The target detection unit 11, upon detection of the communication device itself in the reference image, notifies information indicating the position and the size of the area where the identification marker appears to the image processing unit 12.

The image processing unit 12 performs processing on the reference image so as to be usable for creating a composite image. In this embodiment, the image processing unit 12 is an example of a transparency set unit, and sets a predetermined transparency for each pixel of the reference image or, at least for each pixel included in the area of the reference image in which the communication device appears. For example, the image processing unit 12 sets alpha values, which indicate transparency, for each pixel of the reference image to values corresponding to the predetermined transparency that provides translucency (for example, when the a values are indicated by numbers from 0 to 255, values on the order of 100 to 150). The image processing unit 12 may differentiate the transparency of each pixel in the area of the reference image in which the communication device appears from transparency of each pixel of the other area. For example, the image processing unit 12 may set the transparency of each pixel in the area in which the communication device appears which is lower than the transparency of each pixel of other area. Accordingly, information of the reference image cannot be viewed easily in the area other than the area in which the communication device appears on the composite image, an area showing two or more images in a superimposed manner is reduced, and hence a composite image which is easy to see as a whole is obtained.

The image processing unit 12 may apply an affine transformation to the each pixel of the reference image so that the orientation, position, and size of the communication device in the reference image are transformed to have a predetermined orientation, position, and size. Accordingly, positional alignment which is performed between the image acquired at the time of execution of the cable connection task and the reference image is facilitated. For example, when an identification marker is detected in the reference image, the image processing unit 12 may set a coefficient of a rotational angle of the affine transformation so that a given side (for example, the bottom side) of the identification marker extends in parallel to any one side (for example, the bottom side) of the reference image. When an identification marker is detected by the template matching, the image processing unit 12 may set a coefficient of the rotational angle of the affine transformation to one inverted in positive/negative of an inclination angle of the template at which the template and the reference image matches best. The image processing unit 12 may set a coefficient relating to the scale of the affine transformation so that the length of the identification marker along a given side thereof becomes a predetermined size. In addition, the image processing unit 12 may set a coefficient of a shift of the affine transformation so that a centroid of the area of the reference image including the identification marker matches a predetermined position in the reference image.

In the same manner, when the communication device itself is detected in the reference image, the image processing unit 12 may set a coefficient of the rotational angle of the affine transformation so that a given side (for example, the bottom side) of the communication device extends in parallel to any one side (for example, the bottom side) of the reference image. At this time, when the communication device is detected by template matching, the image processing unit 12 may employ an angle, which is inverted in positive/negative, of inclination of the template at which the template and the reference image matches best as a coefficient of the rotation angle of the affine transformation. The image processing unit 12 may set a coefficient relating to the scale of the affine transformation so that the length of the communication device along a given side thereof becomes a predetermined size. In addition, the image processing unit 12 may set a coefficient of a shift of the affine transformation so that a centroid of the area of the reference image in which the communication device appears matches a predetermined position in the reference image.

The image processing unit 12 may set the orientation, position, and size of the communication device in the reference image to predetermined orientation, position and size by executing the affine transformations by using the respective coefficients of the affine transformation which are set as described above on each pixel of the reference image. The image processing unit 12 may perform the affine transformation on each pixel so that one or two of the orientation, position, and size of the communication device in the reference image become predetermined values. As the position of each pixel after the affine transformation may extend across two or more pixels, the image processing unit 12 may execute interpolation such as bilinear interpolation or bicubic interpolation after execution of the affine transformation.

Specifically, when the image of the communication device in the reference image is aligned in position with the image of the communication device in the image at the time of execution of the cable connection task by view transformation processing, correction of the orientation, position, and size of the communication device in the reference image is omitted as will be described later.

The image processing unit 12 may also convert the luminance value of each pixel of the reference image so that the average value of the luminance values of the pixels in the reference image becomes a predetermined value. Alternatively, the image processing unit 12 may convert the luminance value of each pixel of the reference image so that the contrast of the reference image becomes a predetermined contrast.

In this case, the image processing unit 12 converts the value of each pixel of the reference image from the value of the RGB color system to an HLS color system. The image processing unit 12 calculates the average value of the luminance components of the pixels, and calculates a difference value by subtracting the calculated average value from the predetermined luminance value. The image processing unit 12 adds the difference value to a luminance component of each pixel so that the luminance component of each pixel is corrected. Alternatively, the image processing unit 12 obtains the maximum value and the minimum value of the luminance component of the reference image, and corrects the luminance component each pixel such that the difference between the maximum value and the minimum value becomes a value corresponding to the predetermined contrast. The image processing unit 12 then converts the value of each pixel of the reference image from the value of the HLS color system to the value of the RGB system by using the luminance component after correction.

In addition, the image processing unit 12 may trim the area of the reference image in which the communication device appears.

The image processing unit 12 sends the processed reference image, the position of the communication device in the reference image, and the positional information at the time of acquisition of the reference image to the memory medium access device 5 to cause the memory medium 8 to store the same. When the imaging unit 3 includes a zoom optical system, the image processing unit 12 sends the angle of view and the focal length of the imaging unit 3 at the time of acquisition of the reference image to the memory medium access device 5 together with the reference image to cause the memory medium 8 to store the same.

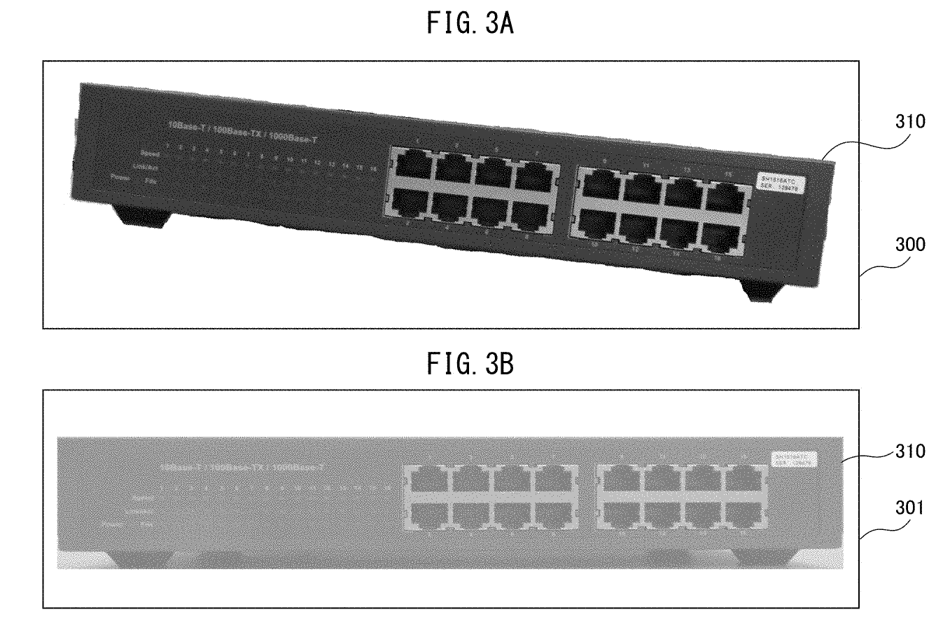

FIG. 3A illustrates an example of the reference image before processing is applied thereto, and FIG. 3B illustrates an example of the reference image after processing has been applied thereto. As illustrated in FIG. 3A, before the processing is applied, a communication device 310 which is represented in the reference image 300 is inclined downward toward the right with respect to the horizontal direction of the reference image 300. In contrast, in the reference image 301 after the processing has been applied as illustrated in FIG. 3B, the orientation of the communication device 310 is corrected so that the horizontal direction of the reference image 300 and the longitudinal direction of the communication device 310 extend parallel to each other. In the reference image 301, the transparency is set for each pixel such that the communication device 310 becomes translucent.

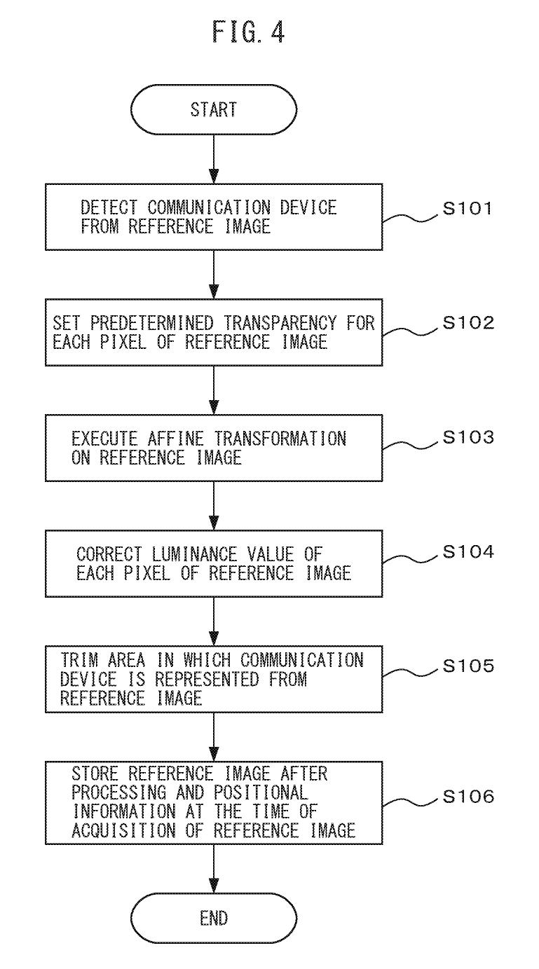

FIG. 4 is an operation flowchart of the reference image registration processing. The control unit 7 registers the reference images according to the operation flowchart each time a reference image is acquired.

The target detection unit 11 detects the communication device from the reference image (step S101). The image processing unit 12 sets a predetermined transparency for each pixel of the reference image (step S102). The image processing unit 12 executes an affine transformation on each pixel of the reference image so that the orientation, position, and size of the communication device in the reference image is transformed to have a predetermined orientation, position, and size (step S103). The image processing unit 12 corrects the luminance value of the each pixel of the reference image (step S104). In addition, the image processing unit 12 may trim the area in which the communication device appears from the reference image (step S105). The image processing unit 12 sends the processed reference image, the position of the communication device in the reference image, and the positional information at the time of acquisition of the reference image to the memory medium access device 5 to cause the memory medium 8 to store the same (step S106). The control unit 7 terminates reference image registration process. The order of processing in Steps S102 to S105 may be interchanged. Steps S103 to S105 may be omitted.

(Image Display Process)

The image display process will be described.

The position aligning unit 13 aligns the image of the communication device acquired by capturing the communication device at the time of execution of the cable connection task (hereinafter, referred to as a “current image”) with the reference image of the communication device (for example, the image to which processing was applied) so as to match these images of the communication device.

For example, the position aligning unit 13 performs template matching between the reference image as a template and the current image to obtain the position where the template matches best and the orientation of the template. In order to do so, the position aligning unit 13 calculates a normalization cross-correlation value between the current image and the template while changing the position and orientation of the template, and determines the positions and the orientation with which the normalization cross-correlation value becomes the maximum as the position and the orientation with which the template matches best. The position aligning unit 13 may use any one of a red component, a blue component, and a green component for each of the reference image and the current image for calculating the normalization cross-correlation value. Alternatively, the position aligning unit 13 may use luminance components which may be obtained by performing color system conversion for each pixel in order to calculate the normalization cross-correlation value in the same manner as the image processing unit 12.

Before performing template matching, the position aligning unit 13 may execute processing on the current image using the target detection unit 11 and the image processing unit 12 to process the current image so that the size of the communication device in the current image becomes a predetermined size. Accordingly, since the sizes of the communication devices in the current image and in the reference image are substantially the same, the position aligning unit 13 may improve the positioning accuracy based on the template matching.

The position aligning unit 13 shifts each pixel of the reference image, which corresponds to the template, so that the template has a position and orientation which match best to the current image, thereby creating a virtual image which is combined with the current image.

Alternatively, the position aligning unit 13 may use view transformation processing to align the reference image with the current image. The position aligning unit 13 uses, for example, positional information at the time of acquisition of the reference image and positional information at the time of acquisition of the current image to perform view transformation on the reference image so as to obtain an image of the communication device virtually taken from the position of the imaging unit 3 at the time of acquisition of the current image toward the imaging direction.

The position aligning unit 13 calculates the position in real space of a point included in each pixel within the area of the reference image in which the communication device appears.

$${X}_{d} = \frac{{Z}_{d}}{{f}_{dr}} \times ( {x}_{d} - \frac{DW}{2} ) \\ {Y}_{d} = \frac{{Z}_{d}}{{f}_{dr}} \times ( {y}_{d} - \frac{DH}{2} ) \\ {f}_{dr} = \frac{\sqrt{{DW}^{2} + {DH}^{2}}}{2 tan \frac{DFovDr}{2}} \qquad ( 1 )$$

Equation (1) is an equation according to a pinhole camera model to obtain the position in a camera coordinate system which is set based on the position of the imaging unit 3 at the time of acquisition of the reference image, as positions (X_{d}, Y_{d}, Z_{d}) in real space corresponding to pixels (x_{d}, y_{d}) in the reference image. In the camera coordinate system, the Xd axis direction and the Yd axis direction are respectively set on a plane orthogonal to an optical axis of the imaging unit 3 to directions corresponding to a horizontal direction and a vertical direction of the reference image. The Zd axis direction is set so as to be parallel to a direction of the optical axis of the imaging unit 3. f_{dr} indicates a focal length of the imaging unit 3 at the time of acquisition of the reference image, and DW and DH respectively indicate the number of pixels in the horizontal direction and the number of pixels in the vertical direction of the reference image. DFovDr indicates a diagonal visual angle of the imaging unit 3 at the time of acquisition of the reference image. Z_{d} indicates a distance along the Zd axis between a point on the communication device located on a position corresponding to a pixel (x_{d}, y_{d}) and the imaging unit 3, and is calculated based on the positional relationship between the position of the imaging unit 3 indicated in the positional information at the time of acquisition of the reference image and the position of the communication device. Since the size of the communication device, the angle of view and the focal length of the imaging unit 3 are known, if the size of the communication device in the reference image is known, the distance from the imaging unit 3 to the communication device is also known. The position aligning unit 13 may calculate the distance Z_{d} on the basis of the size of the communication device in the reference image (for example, the length of the communication device along a specific direction). In order to support the cable connection task, the respective ports of the communication device preferably appear in the reference image and the current image. Therefore, it is expected that the picture of the communication device is taken from a substantially front of surface of the communication device where the ports are provided. Accordingly, it is assumed that the distances Z_{d} between respective points on the communication device appearing on the reference image and the imaging unit 3 along the direction of the optical axis may be the same as each other.

In addition, the position aligning unit 13 transforms coordinates in the camera coordinate system of a point included in each pixel within the area of the reference image in which the communication device appears into coordinates (X_{W}, Y_{W}, Z_{W}) in a virtual view point coordinate system which is set based on the position of the imaging unit 3 at the time of acquisition of the current image according to the following equation. In the virtual view point coordinate system, for example, the Zw axis is set so as to be parallel to the direction of the optical axis of the imaging unit 3 at the time of acquisition of the current image, and the Xw axis is set to the direction corresponding to the horizontal direction in the image after the view transformation on a plane orthogonal to the Zw axis. The Yw axis is set so as to be orthogonal to the Xw axis and the Zw axis.

$$( \begin{matrix}{X}_{W} \\ {Y}_{W} \\ {Z}_{W}\end{matrix} ) = {R}_{DW} ( \begin{matrix}{X}_{d} \\ {Y}_{d} \\ {Z}_{d}\end{matrix} ) + {t}_{DW} \\ \begin{matrix}{R}_{DW} = ( \begin{matrix}1 & 0 & 0 \\ 0 & cos DRotX & - sin DRotX \\ 0 & sin DRotX & cos DRotX\end{matrix} ) \\ ( \begin{matrix}cos DRotY & 0 & sin DRotY \\ 0 & 1 & 0 \\ - sin DRotY & 0 & cos DRotY\end{matrix} ) ( \begin{matrix}cos DRotZ & - sin DRotZ & 0 \\ sin DRot Z & cos DRotZ & 0 \\ 0 & 0 & 1\end{matrix} )\end{matrix} \\ {t}_{DW} = ( \begin{matrix}DLocX \\ DLocY \\ DLocZ\end{matrix} ) \qquad ( 2 )$$

Wherein, R_{DW} is a rotation matrix indicating an amount of rotation included in the affine transformation from the camera coordinate system to the virtual view point coordinate system, and t_{DW} is a shift vector indicating the shift amount included in the affine transformation. DLocX, DLocY, and DLocZ are coordinates of the center of a sensor surface of the imaging unit 3 at the time of acquisition of the reference image in the Xw axis direction, the Yw axis direction, and the Zw axis direction, respectively, in the virtual view point coordinate system, i.e., the coordinates of an original point of the camera coordinate system. DRotX, DRotY, and DRotZ indicate angles of rotation in the direction of the optical axis of the imaging unit 3 at the time of acquisition of the reference image with respect to the Xw axis, the Yw axis, and the Zw axis, respectively.

Subsequently, the position aligning unit 13 projects, for each pixel within the area in which the communication device appears, a point included in the pixel expressed in the virtual view point coordinate system on the virtual image viewed from the position of the imaging unit 3 at the time of acquisition of the current image according to the following equation. Accordingly, the image of the communication device in the virtual image is aligned with the image of the communication device in the current image.

$${x}_{p} = \frac{{f}_{dc} \times {X}_{W}}{{Z}_{W}} + \frac{DW}{2} \\ {y}_{p} = \frac{{f}_{dc} \times {Y}_{W}}{{Z}_{W}} + \frac{DH}{2} \\ {f}_{dc} = \frac{\sqrt{{DW}^{2} + {DH}^{2}}}{2 tan \frac{DFovDc}{2}} \qquad ( 3 )$$

Equation (3) is an equation according to the pinhole camera model like Equation (1). (xₚ, yₚ) indicates the position in the horizontal direction and the position in the vertical direction in the virtual image corresponding to a point (X_{W}, Y_{W}, Z_{W}) in actual space. f_{dc} indicates the focal length of the imaging unit 3 at the time of acquisition of the current image, and DFovDc indicates the diagonal visual angle of the imaging unit 3 at the time of acquisition of the current image. If the optical imaging system of the imaging unit 3 is a single focus optical system, equalities of f_{dr}=_{fdc} and DFovDr=DFovDc are satisfied.

When part of the communication device is hidden by the cable and thus is not visible in the current image, the image of the communication device in the current image might not be adequately aligned with the image of the communication device in the reference image in template matching. In this manner, however, the position aligning unit 13 may align the image of the communication device in the current image with the image of the communication device in the reference image using view transformation processing even when part of the communication device is hidden by the cable and thus is not visible in the current image.

In addition, the position aligning unit 13 may perform template matching between the reference image and the current image within a predetermined range regarding the position of the communication device in the reference image obtained by the view transformation processing. Accordingly, the position aligning unit 13 can align the image of the communication device in the current image with the image of the communication device in the reference image with a high degree of accuracy.

The position aligning unit 13 outputs the obtained virtual image to the combining unit 14.

The combining unit 14 combines the virtual image and the current image to create a composite image. At this time, the combining unit 14 combines the value of each pixel of the virtual image and the value of a corresponding pixel of the current image in accordance with the transparency set to the corresponding pixel to create a composite image by combining the image of the communication device in the reference image and the image of the communication device in the current image. The combining unit 14 sends the composite image to the display control unit 15.

The display control unit 15 displays the obtained composite image on the display screen of the user interface unit 2. When the terminal 1 receives the information that specifies the port which is operated upon from other equipment via the communication interface at the time of execution of the cable connection task, the display control unit 15 may display an index which indicates the specified port together with the composite image. As such an index, the display control unit 15 may use, for example, diagram which schematically illustrates the array of the ports, and the color of the specified port is differentiated from the color of other ports in the diagram.

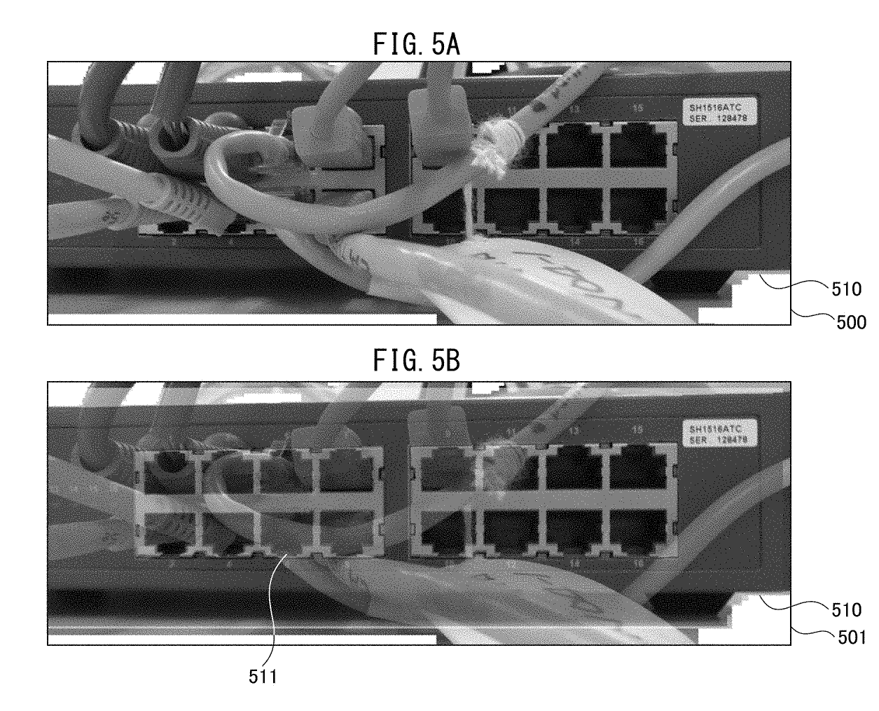

FIG. 5A illustrates an example of the current image, and FIG. 5B illustrates an example of the composite image. In the current image 500, a plurality of cables are connected to communication device 510, and some ports are hidden by the cables and thus are not visible. In contrast, in the composite image 501, the port of the communication device 510 which is not visible in the current image 500, for example, the port 511 is also visible. Therefore, even when a port which is not visible in the current image 500 is the subject of the cable connection task, the worker can identify the port by referring to the composite image 501, and hence the task is facilitated.

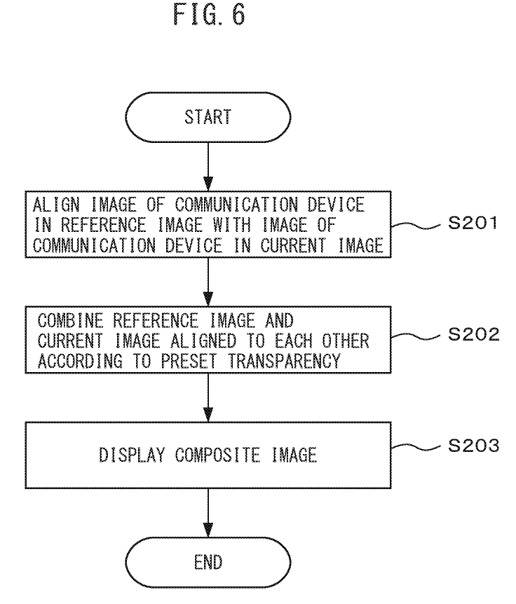

FIG. 6 is an operation flowchart of the image display process. For example, the control unit 7, upon acquisition of the current image from the imaging unit 3, executes the image display process according to the operation flowchart.

The position aligning unit 13 aligns the image of the communication device appearing in the reference image with the image of the communication device appearing in the current image (step S201). The combining unit 14 combines the reference image (i.e., the virtual image) and the current image aligned to each other in accordance with the transparency set for each pixel of the reference image to create a composite image of the image of the communication device in the reference image and the image of the communication device in the current image (step S202). The display control unit 15 displays the composite image on the display screen of the user interface unit 2 (step S203). The control unit 7 then terminates the image display process.

As described above, the image display apparatus aligns and then combines two images obtained by capturing the communication device in different conditions of cable connection. At this time, the image display apparatus sets the transparency of each pixel of one of the images so that the image of the communication device becomes transparent to some extent and thereby creates a composite image in which the respective images of the communication device in the two images are combined. Therefore, even when some of the ports of the communication device are not visible in one of the images, the image display apparatus may present a composite image that makes the port visible to a worker, so that the worker may easily identify the position of each port on the composite image. Consequently, the image display apparatus can support the cable connection task of the worker with respect to the communication device.

According to the modification, the control unit 7 may execute processing of the target detection unit 11 and the image processing unit 12 with respect to the current image instead of the reference image. A predetermined transparency may be set for each pixel of the current image so that the image of the communication device in the current image becomes transparent to some extent. In this case, the control unit 7, upon acquisition of the reference image from the imaging unit 3, may send the reference image itself to the memory medium access device 5 which is stored in the memory medium 8 together with the positional information at the time of acquisition of the reference image.

In this modification as well, a composite image of the image of the communication device in the reference image and the image of the communication device in the current image may be obtained in the same manner as the embodiment described above, and the worker can identify the position of each port of the communication device by referring to the composite image.

According to another modification, the control unit 7 may execute processing of the target detection unit 11 and the image processing unit 12 with respect to the reference image as part of the image display process. In this case, the control unit 7 may, upon acquisition of the reference image from the imaging unit 3, send the reference image itself to the memory medium access device 5 which is stored in the memory medium 8 together with the positional information at the time of acquisition of the reference image. In this modification as well, the same advantageous effects as those in the embodiment described above are obtained. In this case, the image processing unit 12 may set the predetermined transparency for each pixel of the current image.

According to still another modification, the position and the area of the reference image in which the communication device appears may be determined by the worker while referring to the reference image. In this case, the control unit 7 displays the reference image acquired from the imaging unit 3 on the display screen of the user interface unit 2. The worker may input information indicating the position and the area of the communication device, for example, coordinates of four corners of the communication device in the reference image via the user interface unit 2 while referring to the reference image displayed on the display screen.

According to another modification, the terminal 1 may use images obtained by reading a catalog having an image of the communication device appearing thereon or a picture of the communication device with a scanner (not illustrated) connected to the terminal 1 or by imaging with the imaging unit 3 as the reference image. In this case, since things other than the communication device may appear in the reference image, the control unit 7 may trim the area where the communication device appears from the reference image and use the trimmed area as a new reference image.

According to another modification, when the position aligning unit 13 does not use view transformation processing, the positional information acquisition unit 4 may be omitted. In contrast, when the position aligning unit 13 uses view transformation processing, even though the positions of both of the images of the communication device in the reference image and the current image are not detected, the position aligning unit 13 can align the images of the communication device between the two images. Therefore, the target detection unit 11 may be omitted.

According to a further modification, cables may be connected to some of the ports of the communication device acquired as the reference image. However, the ports to which the cables are connected at the time of acquisition of the current image and the ports to which the cables are connected at the time of acquisition of the reference image are preferably different from each other so that all the ports may be identified on the composite image.

The image display apparatus according to the embodiment or the modifications described above may be mounted on a client-server type system.

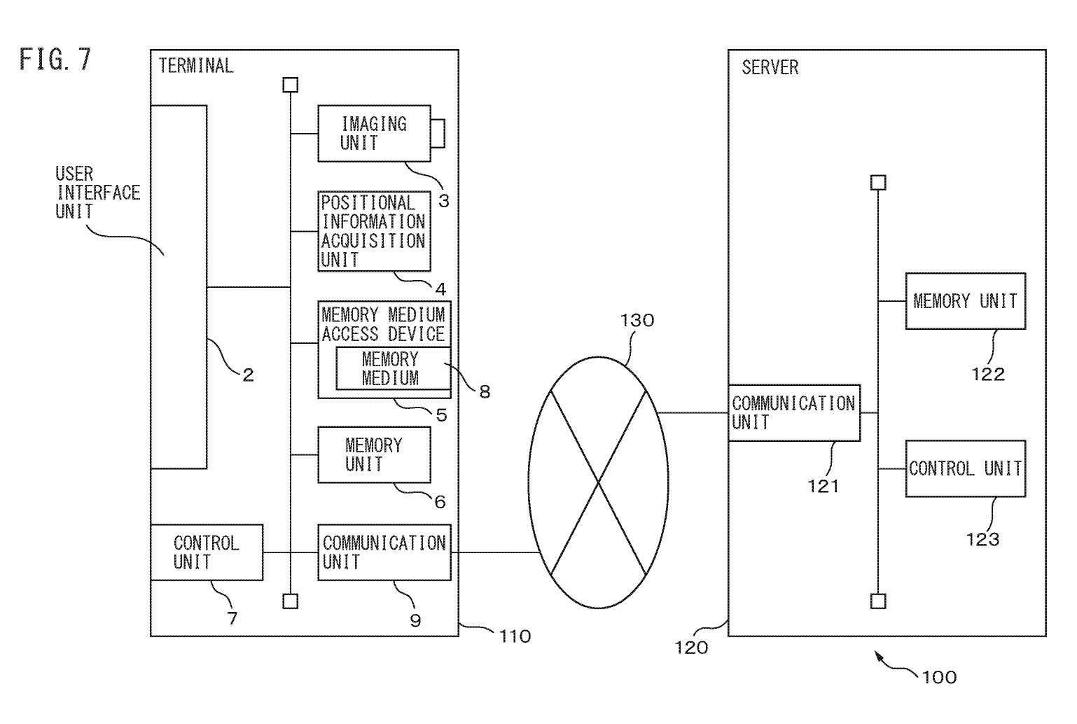

FIG. 7 is a schematic configuration drawing of a client-server system on which the image display apparatus according to an embodiment or the modification described above is mounted. A client-server system 100 includes a terminal 110 and a server 120, and the terminal 110 and the server 120 are able to communicate with each other via a communication network 130. The client-server system 100 may include two or more terminals 110. Similarly, the client-server system 100 may include two or more servers 120. In FIG. 7, the same components as those of the terminal 1 illustrated in FIG. 1 are designated by the same reference numerals.

The terminal 110 includes the user interface unit 2, the imaging unit 3, the positional information acquisition unit 4, the memory medium access device 5, the memory unit 6, the control unit 7, and a communication unit 9. The user interface unit 2, the imaging unit 3, the positional information acquisition unit 4, the memory medium access device 5, the memory unit 6, and the communication unit 9 are connected to, for example, the control unit 7 via signal lines. Refer to the descriptions of the components corresponding to those of the above-described embodiment regarding the user interface unit 2, the imaging unit 3, the positional information acquisition unit 4, the memory medium access device 5, and the memory unit 6.

The control unit 7 includes one or more processors and a peripheral circuit thereof, and controls each unit of the terminal 110. The control unit 7, upon acquisition of an image of the communication device from the imaging unit 3, and upon acquisition of the positional information of the terminal 110 from the positional information acquisition unit 4, transmits the image and the position information to the server 120 via the communication unit 9 together with identification information (for example, an IP address) of the terminal 110.

The control unit 7, upon reception of the composite image from the server 120 via the communication unit 9, displays the composite image on the display screen on the user interface unit 2.

The communication unit 9 includes an interface circuit for connecting the terminal 110 to a communication network 130. The communication unit 9 transmits a transmission signal including an image, positional information of the terminal 110, and identification information of the terminal 110 obtained from the control unit 7 to the server 120 via the communication network 130. The communication unit 9, upon reception of the signal including the composite image from the server 120 via the communication network 130, sends the signal to the control unit 7.

The server 120 includes a communication unit 121, a memory unit 122, and a control unit 123. The communication unit 121 and the memory unit 122 are connected to the control unit 123 via signal lines.

The communication unit 121 includes an interface circuit for connecting the server 120 to the communication network 130. The communication unit 121 sends a signal including the image of the communication device and the positional information of the terminal 110 to the control unit 123 together with the identification information of the terminal 110 from the terminal 110 via the communication network 130. The communication unit 121, upon reception of the transmission signal including the composite image and the identification information of the terminal 110 as information of destination from the control unit 123, outputs the transmission signal to the communication network 130.

The memory unit 122 includes a non-volatile semiconductor memory and a volatile semiconductor memory. In addition, the memory unit 122 may include a hard disk device or an optical recording device. The memory unit 122 stores a computer program or the like for controlling the server 120. The memory unit 122 may stores a computer program for executing image display processing, the image received from the terminal 110, and the positional information of the terminal 110. Furthermore, the memory unit 122 may store the position of the communication device.

The control unit 123 includes one or more processors and a peripheral circuit thereof. The control unit 123 executes processing other than the processing of the display control unit 15 from among the processes of the respective units included in the control unit 7 according to the embodiment or the modifications described above. The control unit 123 creates the composite image of the reference image and the current image of the communication device. The control unit 123 generates a transmission signal including the composite image and directed to the terminal 110, and transmits the transmission signal to the terminal 110 via the communication unit 121 and the communication network 130. When there are two or more servers 120, the two or more servers 120 may execute processing of the respective units included in the control unit 7 in cooperation with each other.

According to the embodiment, each time an image of the communication device is acquired, the terminal 110 may simply transmit the image and the positional information of the terminal 110 to the server 120. Therefore, the computation load of the terminal 110 is reduced.

The control unit 7 of the terminal 110 may execute some of processing of the respective units of the control unit 7 according to the above-described embodiment and the modifications. For example, the control unit 7 of the terminal 110 may execute processing of the position aligning unit 13, the combining unit 14, and the display control unit 15 relating to image display processing. In contrast, the control unit 123 of the server 120 may execute processing of the target detection unit 11 and the image processing unit 12 relating to reference image registration processing. In this case, the terminal 110, upon acquisition of the reference image of the communication device, transmits the reference image to the server 120. In contrast, the server 120 executes reference image registration processing for the received reference image. The server 120 transmits the processed reference image, information indicating the position of the communication device in the reference image, and the like to the terminal 110. The terminal 110 stores the received processed reference image, the information indicating the position of the communication device in the reference image, and the like in the memory medium 8 via the memory medium access device 5. Alternatively, when the terminal 110 acquires the current image of the communication image, the terminal 110 may transmit a request signal that requests the processed reference image to the server 120. The server 120, upon reception of the request signal, may transmit the processed reference image, the information indicating the position of the communication device in the reference image, and the like to the terminal 110. The terminal 110 may execute image display processing when the current image of the communication device is acquired. In this case as well, part of the processing for creating the composite image is executed in the server 120, and thus, the computation load of the terminal 110 is reduced.

The terminal that acquires the reference image and transmits the same to the server 120 and the terminal that acquires the current image, transmits the same to the server 120, and receives the composite image from the server 120 may be different from each other.

Functions of the respective units of the image display apparatus according to the embodiments or the modifications thereof described above may be implemented by a computer program executed on a processor. Such a computer program may be provided in a form recorded in a computer readable recording medium such as a magnetic recording medium or an optical recording medium. However, the recording medium does not include a carrier wave.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An image display apparatus comprising:
a processor configured to:
set predetermined transparency for each pixel of at least one of a first image and a second image, the first image including an image of a communication device including a plurality of ports in a first state in a cable connection and the second image including an image of the communication device in a second state in the cable connection;
align the image of the communication device included in the first image with the image of the communication device included in the second image;
combine the first image and the second image aligned to each other according to the transparency to create a composite image; and
display the composite image on a display apparatus.

2. The image display apparatus according to claim 1, further comprising:
a camera configured to capture the communication device to create the first image and the second image; and
a positional information acquisition device configured to acquire first positional information indicating a position and an imaging direction of the camera at the time of creation of the first image and second positional information indicating the position and the imaging direction of the camera at the time of creation of the second image, wherein
the alignment of the image of the communication device included in the first image with the image of the communication device included in the second image includes executing view transformation processing on the first image based on the first positional information and the second positional information so that the image of the communication device included in the first image becomes an image which may be obtained by capturing the communication device in the imaging direction at the time of creation of the second image from the position of the camera at the time of creation of the second image.

3. An image display method comprising:
setting predetermined transparency for each pixel of at least one of a first image and a second image, the first image including an image of a communication device including a plurality of ports in a first state in a cable connection and the second image including an image of the communication device in a second state in the cable connection;
aligning the image of the communication device included in the first image with the image of the communication device included in the second image;
combining the first image and the second image aligned to each other according to the transparency to create a composite image; and
displaying the composite image on a display apparatus.

4. The image display method according to claim 3, further comprising:
acquiring first positional information indicating a position and an imaging direction of a camera at the time of creation of the first image and second positional information indicating the position and the imaging direction of the camera at the time of creation of the second image, the camera being configured to capture the communication device to create the first image and the second image, wherein
the alignment of the image of the communication device included in the first image with the image of the communication device included in the second image includes executing view transformation processing on the first image based on the first positional information and the second positional information so that the image of the communication device included in the first image becomes an image which may be obtained by capturing the communication device in the imaging direction at the time of creation of the second image from the position of the camera at the time of creation of the second image.

5. A non-transitory computer-readable recording medium having recorded thereon an image display computer program that causes a computer to execute a process comprising:
setting predetermined transparency for each pixel of at least one of a first image and a second image, the first image including an image of a communication device including a plurality of ports in a first state in a cable connection and the second image including an image of the communication device in a second state in the cable connection;
aligning the image of the communication device included in the first image with the image of the communication device included in the second image;
combining the first image and the second image aligned to each other according to the transparency to create a composite image; and
displaying the composite image on a display apparatus.
